(19) United States
(12) Patent Application Publication
(10) Pub. No.: US 2007/0052933 A1
(43) Pub. Date: Mar. 8, 2007

(54) Projector having a scatter blocking member

(75) Inventors: Myung-ryul Jung, Suwon-si (KR); Kyung-hwan Kim, Suwon-si (KR); Byung-jo Kang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/409,047

(22) Filed: Apr. 24, 2006

(30) Foreign Application Priority Data
Sep. 5, 2005 (KR) 2005-0082192

(51) Int. Cl. G03B 21/14

(52) U.S. Cl. 353/88

(57) ABSTRACT

The present invention relates to a projector having a light source and a display device generating an image by using light emitted from the light source. A projection lens projects an image generated from the display device. A scatter blocking member is disposed between the display device and the projection lens to guide the image from the display device to the projection lens and has a surface-processed cylindrical shape. Thus, the projector provides relatively definite pictures by blocking reflected and scattered light.

### CROSS-REFERENCE TO RELATED APPLICATIONS

This application claims the benefit under 35 U.S.C. § 119(a) of Korean Patent Application No. 2005-0082192, filed on Sep. 5, 2005, in the Korean Intellectual Property Office, the entirety of which is hereby incorporated by reference.

### BACKGROUND OF THE INVENTION

1. Field of the Invention

The present invention relates to a projector. More particularly, the present invention relates to a projector for forming relatively definite pictures.

2. Description of the Related Art

Generally, a display device that forms an image includes an optical system having a display device and an optical source providing light with the optical system to magnify and project the image formed by the display device onto a screen. The display device is classified into several types according to a displaying method and a visual type.

According to the displaying method, it can be classified into CRT (cathode ray tube), LCD (liquid crystal display), DLP (digital light processing) and PDP (plasma display panel) devices. The CRT displays an image by striking light using an electronic gun on a surface covered with fluorescent material. The LCD displays an image by providing current to electrodes on a thin panel that consists of small pixels. The DLP uses a digital device deciding the blocking and opening of light through a circuit board reflected on the surface of a DMD (digital micro-mirror device). The PDP uses a gas discharging principle.

According to the visual type, the display device can be classified into a direct-view image display device directly observing a display device, and a projection-type image device indirectly observing a projected image.

Generally, the projector includes an optical system including the display device, such as a DMD, and a light source providing light with the optical system to magnify and project the image formed by the display device onto a screen. Also, the projector can be classified into a single panel type using one display and a triple panel type using three displays. Recently, a variety of technologies have been under development to make conventional projectors more compact, light-weight and high-quality. Particularly, developments for definitely projecting an image onto a screen have been actively made.

To obtain a high-resolution projection image, a projection-type LCD is disclosed in Japanese Patent First Publication No. 04-305637 (Oct. 28, 1992). The conventional invention has a projecting light source unit, an LCD, and a projecting optical system having a scattering light removing device integrated with a projection lens in which the F value (a focal distance/an effective diameter of the lens) of the projection lens ranges from 5 to 22. In the conventional invention with this structure, by integrating the scattering light removing device with the projection lens to prevent the scattering of the projected light, the projection-type LCD can be miniaturized, thereby obtaining the high-resolution image with a relatively simple lens configuration.

However, in such a projector, an optical system casing accommodates the optical system, such as a projecting light source unit, an LCD, and a projecting optical system, and so forth, instead of a casing forming the outer appearance thereof. Inside this optical system casing, not only the light is projected from a lighting system but also the light is reflected or scattered from an internal wall of devices inside the optical system casing, thereby effecting an optical path and producing scattering light that leads to a poor image displayed on a screen.

Accordingly, a need exists for a projector having a scatter blocking member that blocks reflected and scattered light to provide improved quality of a projected image.

### SUMMARY OF THE INVENTION

An object of the present invention is to provide a projector for providing relatively definite pictures by blocking reflected and scattered light.

Additional objects of the invention will be set forth in the description that follows, and in part, will be apparent from the description, or may be learned by practice of the invention.

The foregoing and other objects are substantially realized by providing a projector having a light source, and a display device generating an image by using light emitted from the light source. A projection lens projects an image generated from the display device. A scatter blocking member is disposed between the display device and the projection lens to guide the image from the display device to the projection lens, and has a surface-processed cylindrical shape.

According to an aspect of the present invention, the scatter blocking member has a polygonal shape with a section larger than that of an optical path to accommodate the optical path in the cylindrical interior thereof.

According to an aspect of the present invention, the projector includes a reflection mirror reflecting the light emitted from the light source onto the display device. A cut-out part is formed in an area of the scatter blocking member that interferes with the optical path from the light source toward the reflection mirror.

According to an aspect of the present invention, a mirror accommodating part is formed in an area of the scatter blocking member that interferes with the reflection mirror.

According to an aspect of the present invention, the projector includes a reflection mirror reflecting the light emitted from the light source onto the display device. A cut-out part is formed in an area of the scatter blocking member that interferes with the optical path from the light source toward the reflection mirror.

According to an aspect of the present invention, a mirror accommodating part is formed in an area of the scatter blocking member that interferes with the reflection mirror.

According to an aspect of the present invention, the scatter blocking member is either aluminum or spring steel.

According to an aspect of the present invention, the scatter blocking member is surface-processed to substantially prevent reflecting or scattering of the light.

According to an aspect of the present invention, the display device includes a DMD (digital micro-mirror device).

According to an aspect of the present invention, the display device has one DMD.

Other aspects, advantages, and salient features of the invention will become apparent from the detailed description, which, taken in conjunction with the annexed drawings, discloses preferred exemplary embodiments of the invention.

### BRIEF DESCRIPTION OF THE DRAWINGS

The accompanying drawings, which are included to provide a further understanding of the invention and are incorporated in and constitute a part of this specification, illustrate exemplary embodiments of the invention and together with the description serve to explain the principles of the invention.

FIG. 1 is a perspective view of an optical system casing combined with a common projector;

FIG. 2 is a schematic diagram illustrating the optical system of a projector in accordance with an exemplary embodiment of the present invention;

FIG. 3 is a perspective view of a scatter blocking member; and

FIG. 4 is a schematic diagram illustrating an optical path of the optical system.

Throughout the drawings, like reference numerals will be understood to refer to like parts, components and structures.

### DETAILED DESCRIPTION OF EXEMPLARY EMBODIMENTS

Reference will now be made in detail to the embodiments of the present invention, examples of which are illustrated in the accompanying drawings. The exemplary embodiments are described below to explain the present invention with reference to the figures.

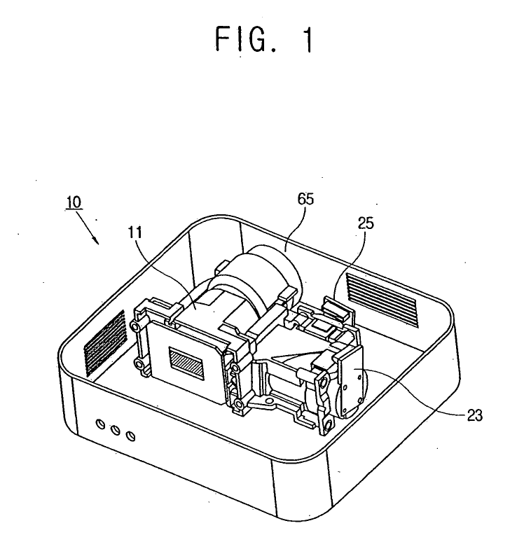

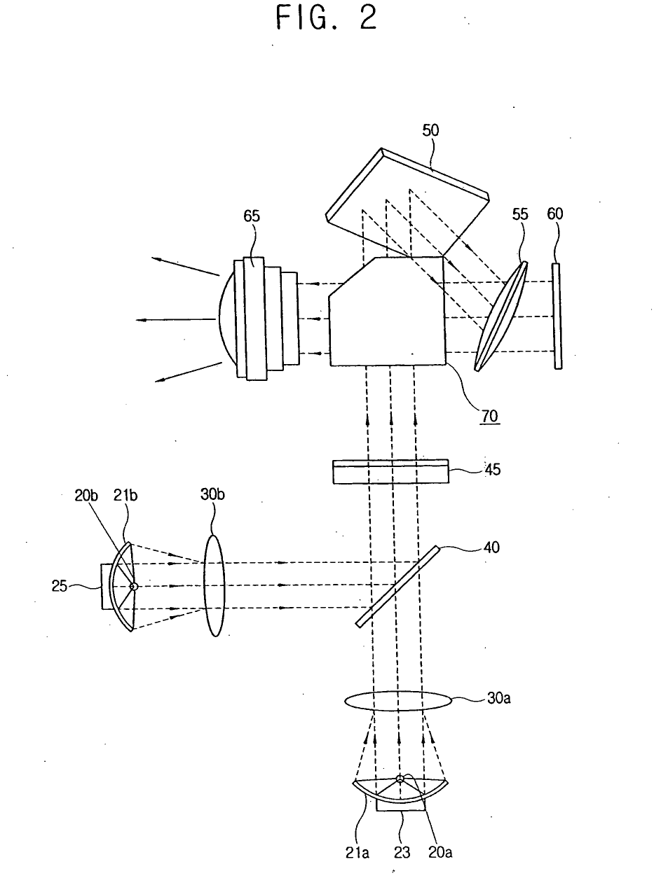

As shown in FIGS. 1 and 2, a projector according to an exemplary embodiment of the present invention includes a light sources 20a and 20b that emits light. A display device 60 generates an image by using the light from the light sources 20a and 20b. A projection lens 65 projects the image generated from the display device 60. A cylindrical scatter blocking member 70, which is surface-processed and disposed between the display device 60 and the projection lens 65, guides the image from the display device 60 to the projection lens 65. As shown in FIG. 2, the projector 10 may include collection lenses 30a and 30b that collect light from the light sources 20a and 20b in parallel, a dichroic mirror 40 that projects and reflects light according to its wavelength, and a fly-eye lens 45 that makes the brightness of the light substantially uniform. The projector 10 includes an optical system casing 11 accommodating these components. Hereinafter, according to the exemplary embodiment of the invention, the description will be made to a single panel type with one display device 60 forming an image as an example of the projection-type display.

As shown in FIGS. 1 and 2, the light sources 20a and 20b may include a plurality of LEDs (light emitting diodes) emitting light. The light sources 20a and 20b are driven by light source boards 23 and 25. The light sources 20a and 20b may be provided with a plurality of LEDs respectively emitting lights of red, green, and blue, and is connected to the respective light source boards 23 and 25, which support and operate the LEDs. For example, the LED emitting the green light is supported on the first light source board 23, and the LED emitting the blue and the red light may be supported on the second light source board 25. A heat radiating plate (not shown) may be disposed on one side of the respective light source boards 23 and 25 for radiating heat generated from the LEDs. Alternatively, the light sources 20a and 20b may be provided with an arc-typed discharge lamp, such as a mercury lamp, a metal halide lamp, or a xenon lamp, instead of the LEDs. Reflection plates 21a and 21b reflecting the light from the light sources 20a and 20b may be further provided as necessary.

As shown in FIG. 2, the collection lenses 30a and 30b are disposed between the light sources 20a and 20b and the dichroic mirror 40 and collects in parallel the light emitted from the light sources 20a and 20b.

As shown in FIG. 2, the dichroic mirror 40 is disposed between the light sources 20a and 20b and the reflection mirror 50, and reflects or transmits light selectively according to the wavelength of the light from the light sources 20a and 20b. The dichroic mirror 40 has a reflection surface on which zinc sulfide (ZnS) or titanium oxide (TiO2) with high refractive index, and magnesium fluorine (MgF2) with low refractive index are alternately deposited as thin films to control the reflection characteristic according to the wavelength by controlling the thickness and the number of the films. For example, the dichroic mirror 40 transmits a green light and reflects a blue and a red light.

As shown in FIG. 2, the fly-eye lens 45 is disposed between the dichroic mirror 40 and the reflection mirror 50 and provides a large screen in a small space by making the brightness of light substantially uniform. The fly-eye lens 45 includes micro lenses each having a substantially rectangular sectional shape.

As shown in FIG. 2, the reflection mirror 50 is disposed between the fly-eye lens 45 and a field lens 55 and reflects the light emitted from the light sources 20a and 20b to the field lens 55.

As shown in FIG. 2, the field lens 55 is disposed between the reflection mirror 50 and the display device 60 and emits without loss the light emitted from the light sources 20a and 20b to the display device 60.

As shown in FIG. 2, the display device 60, generates an image by using the light emitted from the light sources 20a and 20b. The display device 60 may include a DMD (digital micro-mirror device). The DMD as a semiconductor chip, with which hundreds of thousands of micro driving mirrors are integrated, generates the image using the emitted light. In the DMD, hundreds of thousands of mirrors, which switch more than five hundred thousand times a second, digitally control the light. The projector with the DMD controls a reflecting period of time of light onto the micro driving mirrors and projects the light, thereby obtaining a high efficiency of use of light. When the display device 60 has one DMD, the scatter blocking member 70, which will be described later, may be installed in the space between the display device 60 and the projection lens 65. However, when the display device 60 has three DMDs, which includes a prism between the display device 60 and the projection lens 65, there is no space between the prism and the projection lens 65, and thus, it is difficult to locate the scatter blocking member 70 therebetween. However, the scatter blocking member may be installed selectively in a space between the light sources 20a and 20b and the reflection mirror 50, as necessary.

As shown in FIG. 2, the projection lens 65 magnifies the image formed by the display device 60 and projects the image onto the screen (not shown). The projection lens 65, as necessary, may selectively include the functions of magnification and reduction of pictures and screen focusing.

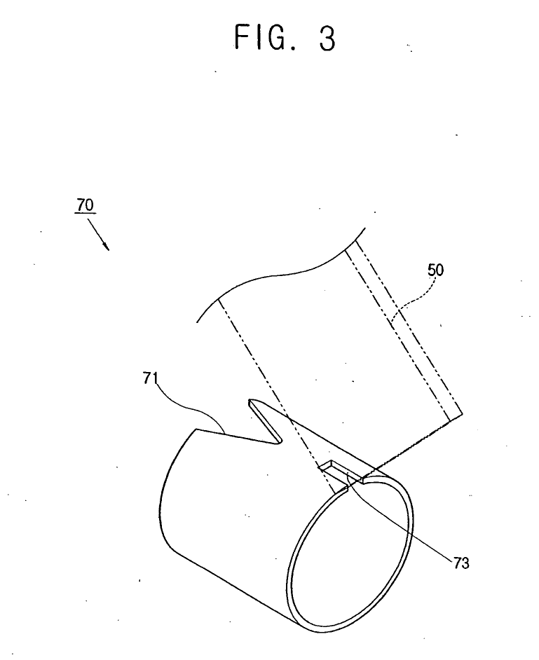

As shown in FIGS. 2 and 3, the scatter blocking member 70 is disposed between the display device 60 and the projection lens 65 to guide the image from the display device 60 to the projection lens 65. The scatter blocking member 70 has a surface-processed cylindrical shape. The scatter blocking member preferably has a polygonal shape having a section larger than that of the optical path to guide the image by accommodating an optical path within the cylinder. Such a polygonal shape, when considering cost, size and so forth, is preferably a cylindrical shape. A cut-out part 71 is formed in the scatter blocking member 70 in the area interfering with the optical path proceeding from the light sources 20a and 20b toward the reflection mirror 50. A mirror accommodation part 73 is formed in the area interfering with the reflection mirror 50. The scatter blocking member 70 is preferably made of metal, including aluminum, and alternatively may use spring steel. The scatter blocking member 70 is surface-processed with flatting black to prevent the light and the image from being reflected and scattered. Accordingly, the scatter blocking member 70 substantially prevents the emitted light from the light sources 20a and 20b, which is reflected and scattered, from affecting the image projected from the display device 60 onto the projection lens 65 and blocks the light reflected and scattered from the internal wall of the devices, thereby providing a definite picture on the screen.

As shown in FIG. 3, the cut-out part 71 is formed by cutting out an area of the scatter blocking member 70 that interferes with the optical path proceeding from the light sources 20a and 20b to the reflection mirror 50. Preferably, the cut-out part 71 has a polygonal shape. The cut-out part 71 is needed, as in a small projector, such that the scatter blocking member 70 does not interfere with the optical path due to a limited internal space of the projector 10. Accordingly, the cut-out part 71 may not be formed according to the size of the projector 10.

As shown in FIG. 3, the mirror accommodating part 73 is formed by cutting out an area of the scatter blocking member 70 interfering with the reflection mirror 50. The mirror accommodating part 73 is needed, as in a small projector, such that the scatter blocking member 70 does not interfere with the reflection mirror 50 due to a limited internal space of the projector 10. Accordingly the mirror accommodating part 73 may not be formed according to the size of the projector 10.

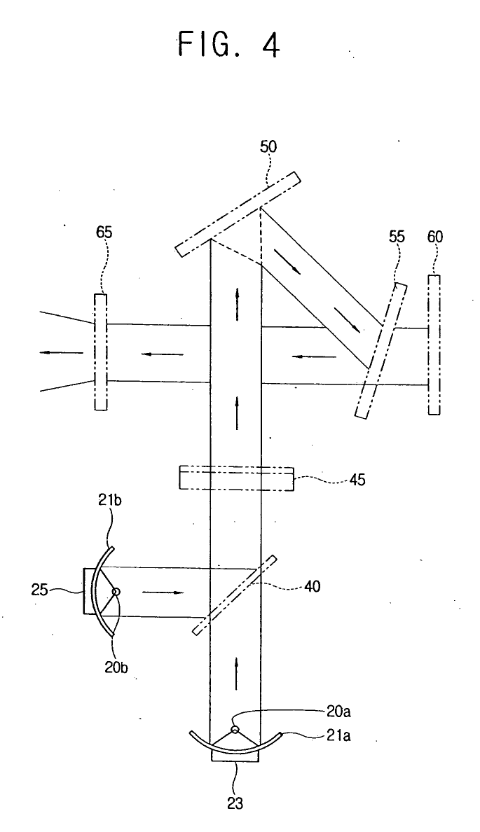

With this configuration, an operation and an optical path of the projector 10, according to exemplary embodiments of the present invention, will be described as follows by referring to FIG. 4

First, the respective light source panels 23 and 25 operate the light sources 20a and 20b, such as an LED or a mercury lamp, to emit light. Part of the light from the light sources 20a and 20b may be reflected onto the collection lenses 30a and 30b (FIG. 2) by the reflection plates 21a and 21b. The collection lenses 30a and 30b (FIG. 2) collect the emitted light in parallel. The dichroic mirror 40 transmits or reflects selectively the light according to the wavelength of the light. For example, the dichroic mirror 40 may transmit a green light, and may reflect a blue and a red light.

The light having a substantially uniform brightness through the fly-eye lens 45 is reflected from the reflection lens 50 and reaches the display device 60 via the field lens 55.

In the process, the light from the light sources 20a and 20b is scattered or reflected onto devices outside of the optical path.

The display device 60 generates an image using the emitted light, and directs the light to the projection lens 65 at a predetermined angle. The scatter blocking member 70 (FIG. 2) is installed between the display device 60 and the projection lens 65 to guide the image toward the projection lens 65. That is, the optical path guided from the light sources 20a and 20b to the reflection mirror 50 and the image path from the display device 60 to the projection lens 65 are misaligned with each other, and the scatter blocking member 70 (FIG. 2) and the optical path may interfere due to the limited space within the projector 10. The scatter blocking member 70 (FIG. 2) substantially prevents the reflection and scattering of the projected image, and blocks the inflow of light reflected and scattered from various kinds of devices. The projection lens 65 magnifies and projects an image onto a screen. Hence, the light scattered around the pictures is decreased or removed, such that definite pictures may be obtained.

As described above, according to aspects of exemplary embodiments of the present invention, a scatter blocking member 70 efficiently decreases or prevents the effect of not only the light emitting from the light source but also the light reflected and scattered from the internal wall of the optical system, to thereby form a relatively definite picture.

It will be apparent to those skilled in the art that various modifications and variation may be made in the present invention without departing from the spirit or scope of the invention. Thus it is intended that the present invention cover the modifications and variations of this invention provided they come within the scope of the appended claims and their equivalents.

What is claimed is:

1. A projector, comprising:
at least one light source;
a display device generating an image by using light emitted from the at least one light source;
a projection lens projecting the image generated by the display device; and
a scatter blocking member disposed between the display device and the projection lens to guide the image from the display device to the projection lens, and a surface of the scatter blocking member being surface-processed to substantially prevent reflecting and scattering of light.

2. The projector according to claim 1, wherein
the scatter blocking member has a polygonal shape with a section larger than that of an optical path to accommodate the optical path within the interior of the scatter blocking member.

3. The projector according to claim 2, wherein
the scatter blocking member has a cylindrical shape.

4. The projector according to claim 1, wherein
a reflection mirror reflects light emitted from the at least one light source onto the display device.

5. The projector according to claim 4, wherein
a cut-out part is formed in an area of the scatter blocking member such that the scatter blocking member does not substantially interfere with the optical path from the at least one light source to the reflection mirror.

6. The projector according to claim 4, wherein
a mirror accommodating part is formed in an area of the scatter blocking member such that the scatter blocking member does not interfere with the reflection mirror.

7. The projector according to claim 3, wherein
a reflection mirror reflects the light emitted from the at least one light source onto the display device.

8. The projector according to claim 7, wherein
a cut-out part is formed in an area of the scatter blocking member such that the scatter blocking member does not substantially interfere with the optical path from the at least one light source toward the reflection mirror.

9. The projector according to claim 5, wherein
a mirror accommodating part is formed in an area of the scatter blocking member such that the scatter blocking member does not interfere with the reflection mirror.

10. The projector according to claim 1, wherein
the scatter blocking member is made of aluminum.

11. The projector according to claim 1, wherein
the scatter blocking member is made of spring steel.

12. The projector according to claim 1, wherein
the display device has at least one DMD (digital micro-mirror device).

13. A projector, comprising:
at least one light source;
a display device generating an image by using light emitted from the at least one light source;
a projection lens projecting the image generated by the display device;
a reflection mirror reflecting the light emitted from the at least one light source onto the display device; and
a scatter blocking member disposed between the display device and the projection lens to guide the image from the display device to the projection lens, the scatter blocking member including
a surface of the scatter blocking member being surface-processed to substantially prevent reflecting and scattering of light;
a cut-out part formed in an area of the scatter blocking member such that the scatter blocking member does not substantially interfere with the optical path from the at least one light source to the reflection mirror; and
a mirror accommodating part formed in an area of the scatter blocking member such that the scatter blocking member does not interfere with the reflection mirror.

14. The projector according to claim 13, wherein
the scatter blocking member has a polygonal shape with a section larger than that of an optical path to accommodate the optical path within the interior of the scatter blocking member.

15. The projector according to claim 14, wherein
the scatter blocking member has a cylindrical shape.

16. The projector according to claim 13, wherein
the scatter blocking member is made of aluminum.

17. The projector according to claim 13, wherein
the scatter blocking member is made of spring steel.

18. The projector according to claim 13, wherein
the display device has at least one DMD (digital micro-mirror device).
